(19) United States
(12) Patent Application Publication
(10) Pub. No.: US 2002/0026715 A1
(43) Pub. Date: Mar. 7, 2002

(54) SPOON

(76) Inventor: BERND BOHM-VAN DIGGELEN, NURNBERG (DE)

Correspondence Address: VENABLE BAETJER HOWARD & CIVILETTI, PO BOX 34385, WASHINGTON, DC, 20043-9998, US

(21) Appl. No.: 09/463,310

(22) PCT Filed: Jul. 17, 1998
(86) PCT No.: PCT/DE98/02006

(30) Foreign Application Priority Data
Jul. 22, 1997 (DE) 197 31 429.5

(51) Int. Cl. A47J 43/28

(52) U.S. Cl. 30/328; 30/324

(57) ABSTRACT

The invention relates to a spoon for receiving soft or liquid food. Said spoon has a handle with an attached mouthpiece constructed of soft and flexible material. The aim of the invention is to significantly simplify the manner in which food is received by small children and people with facial paralysis. The spoon has a practical shape in that the mouthpiece is trough-shaped and concave and has a level defining upper edge, whereby the thickness of the mouthpiece in the front and on the lateral side is proportional so that its concave shape can be inverted by the pressure of the tongue (Z) during swallowing and the mouthpiece can adapt to the arched shape of the hard palate (G) in a sagital and transversal direction.

The invention relates to a spoon for receiving soft or liquid food, having a handle and an adjoining mouthpiece, which comprises a soft, flexible material.

DE 29 05 831 A 1 discloses a child spoon in which an extended handle supports at one end a bowl comprising a soft, flexible material, with one part of the bowl serving to receive and hold viscous and similar foods; the bowl is extended and flattened in the axial direction, and the part of the bowl that serves to receive and hold foods has a curved surface.

This known child spoon made of a soft material is intended to be better received by children, because they are accustomed to contact with soft objects. Furthermore, this known child spoon is intended to be better adapted to the conformation and movements of a child's mouth, and prevent injuries by the bowl, for example due to bumping against the teeth or lips.

This known spoon has a flat bowl shape that is extended and flat in the axial direction. A mouthpiece of this type, being flat in the transversal direction, and in which the radius of curvature is clearly smaller in the sagittal direction near the palate than the lower radius near the tongue, is structurally suited only for bending the forward spoon edge upward with the tongue. This does not press the food out of the spoon, however. The tongue does not approach the forward hard palate closely enough to trigger the swallowing reflex, so this spoon must be withdrawn from the mouth before the food is swallowed, as is the case for all spoons made of a hard material.

The action of mimic muscles (facial muscles), primarily the orbicularis oris (the annular muscle surrounding the mouth opening), is necessary to keep the food located on the spoon inside the oral cavity. The mouthpiece of the spoon is thus sealed at the transition to the handle. At the same time, the spoon can be pulled out of the oral cavity, with the food remaining in the oral cavity. The swallowing process follows.

For persons whose facial muscles are non-functioning, or have limited functioning, as well as for persons who have not yet learned or are not capable of the motor process of the facial muscles for the above-described intake of food, eating with the known spoons is impossible, or difficult and lengthy, even with the assistance of another person.

Persons who fit this category include:

infants whose sole nourishment thus far has been from breast- or bottle-feeding;

persons experiencing facial paralysis following an accident or stroke; and

persons with other facial paralysis, for example due to illness, or limited facial function.

It is the object of the invention to modify a spoon of the type mentioned at the outset such that food intake is greatly facilitated, or even becomes practical, for the persons listed above.

This object is accomplished according to claim 1 in that the mouthpiece is trough-shaped and concave and has a upper limiting edge, which lies in one plane, with the material thickness of the mouthpiece in the forward and lateral regions being selected such that its concave shape is converted into a convex shape by the pressure of the tongue during the swallowing process, and the mouthpiece can be adapted in the sagittal and transversal directions to the curved shape of the hard palate.

To permit a simple and inexpensive production of the spoon, a modification of the invention provides that the mouthpiece and the handle are produced in one piece.

For proper functioning of the spoon, in accordance with a further embodiment of the invention, it is provided that the mouthpiece comprises a material, for example elastomer, preferably having a Shore hardness in a range of 60 to 80.

The advantages attained with the invention are, notably, that the eating process is facilitated, or even becomes practical, for the persons mentioned above, because the swallowing process can take place while the spoon remains in the mouth. A further advantage results from the modification of the invention according to dependent claims 2 and 3. The use of a material having a Shore hardness in a range of 60 to 80 assures the material thickness and minimum rigidity of the spoon mouthpiece that are necessary for proper functioning, on the one hand, and, on the other hand, a sufficient stability for the handle design in order to take into consideration all physiological and physical forces that may occur. It is therefore also possible to produce the entire spoon in one piece.

An embodiment of the invention is illustrated in the drawing and described in detail below.

Shown are in:

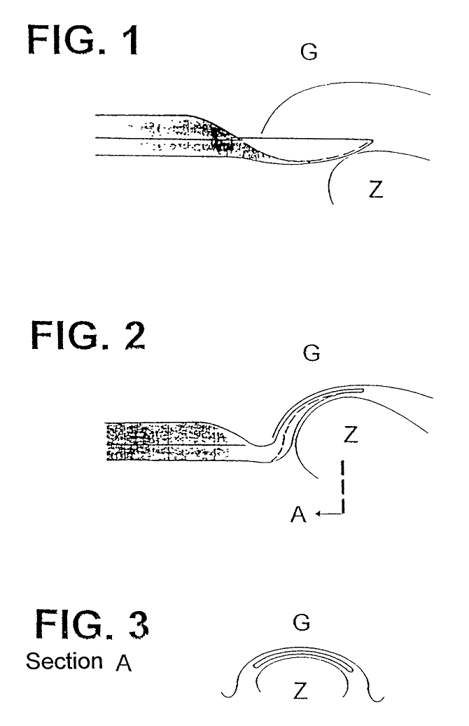

FIG. 1 a longitudinal section of a spoon according to the invention, in the non-stressed state;

FIG. 2 a longitudinal section of the spoon during the swallowing process;

FIG. 3 a cross-section of a spoon according to FIG. 2, along the line A;

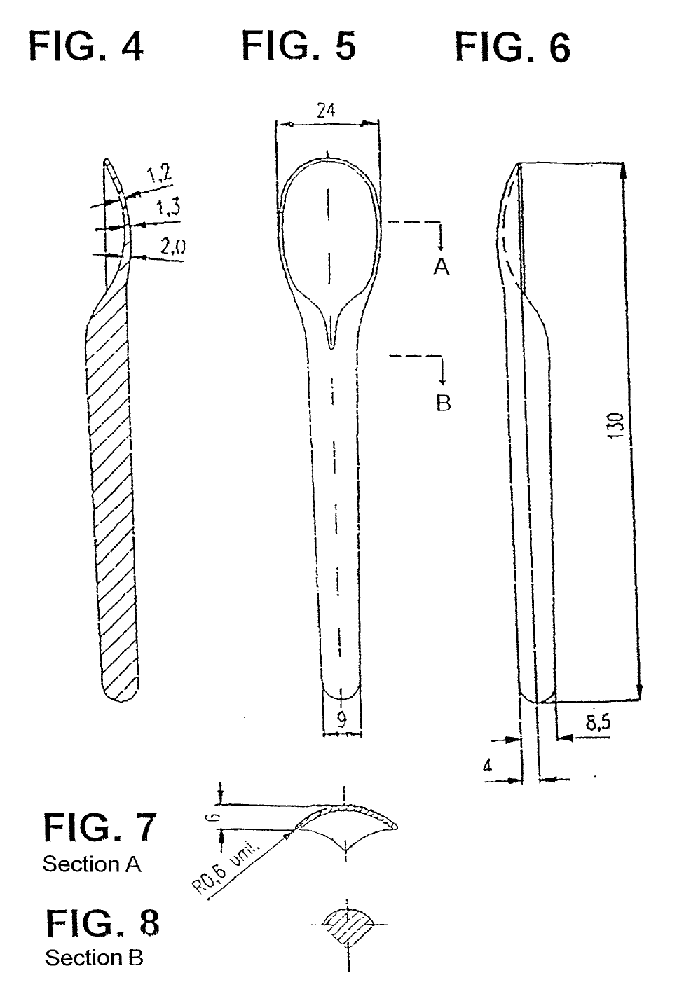

FIG. 4 a longitudinal section of a functional sample of a spoon according to the invention, with a list of dimensions;

FIG. 5 a plan view of the sample according to FIG. 4, with a list of dimensions;

FIG. 6 a further longitudinal section of the sample, also with a list of dimensions;

FIG. 7 a cross-section of a spoon according to FIG. 5, along the line A; and

FIG. 8 a cross-section of a spoon according to FIG. 5, along the line B.

FIG. 1 shows a spoon that is inserted into an oral cavity, with the concave mouthpiece carrying food. FIG. 1 also shows the palate P and the tongue T, which is initially only touching the mouthpiece.

FIG. 2 shows the position of the tongue T during the swallowing process, during which the tongue presses the mouthpiece of the spoon located in the oral cavity flat against the palate P, thereby pressing the food laterally out of the spoon. The tongue converts the trough-shaped, concave mouthpiece into a convex one. In this position, in which the tongue T approaches the forward hard palate P, the swallowing reflex can be triggered. No cooperation with mimic muscles, particularly the orbicularis oris (the annular muscle around the mouth opening), is necessary for keeping the food on the spoon located in the mouth. The spoon is not removed from the mouth until the swallowing reflex is complete, and no more food is on the spoon.

FIG. 3 is a cross-sectional representation of how the tongue T presses the spoon against the palate P, and how the mouthpiece is congruently adapted to the curvature of the palate P in the sagittal and transversal directions. In this state, the tongue T approaches the palate P up to the thickness of the spoon, so the swallowing reflex can be triggered.

FIGS. 4 through 8 show the precise dimensions of the spoon according to the invention, as it is already being mass-produced and used with tremendous success.

1. A spoon for receiving soft or liquid food, having a handle and an adjoining trough-shaped, concave mouthpiece, which comprises a soft, flexible material, characterized in that the limiting edge of the mouthpiece and the longitudinal axis of the handle lie in the same plane, and the largest width of the mouthpiece, for example measuring about 24 mm, is approximately equal to four times its greatest height, while the material thickness of the mouthpiece in the direction toward the tip preferably decreases from about 2 mm in the vicinity of the handle to about 1.3 mm in the center, and to about 1.2 mm in the forward third of the spoon.

2. The spoon according to claim 1, characterized in that the handle and the mouthpiece are produced in one piece, and its cross-sectional shape increases its bending strength, with the greatest expansions occurring in the plane of the limiting edge of the mouthpiece, and transversely to its plane.

3. The spoon according to claim 1 or 2, characterized in that the mouthpiece comprises a material, for example elastomer, that preferably has a Shore hardness in a range of 60 to 80.
